(19) United States
(12) Patent Application Publication
(10) Pub. No.: US 2018/0194383 A1
(43) Pub. Date: Jul. 12, 2018

(54) MOTORIZED SHOPPING TROLLEY

(71) Applicant: FORD MOTOR COMPANY, Dearborn, MI (US)

(72) Inventors: Uwe Gussen, Huertgenwald (DE); Christoph Arndt, Moerlen (DE); Frank Petri, Erftstadt (DE)

(73) Assignee: FORD MOTOR COMPANY, Dearborn, MI (US)

(21) Appl. No.: 15/863,697

(22) Filed: Jan. 5, 2018

(30) Foreign Application Priority Data
Jan. 9, 2017 (DE) 10 2017 200 155.0

(51) Int. Cl. B62B 5/00; B62B 5/02

(52) U.S. Cl. CPC B62B 5/0076; B62B 5/02; B62B 5/0073; B62B 5/0033

(57) ABSTRACT

A motorized shopping trolley has a frame and two wheels which are driven by a drivetrain. A handle for pulling and/or pushing the trolley is provided with a force sensor which detects a force acting on the handle when being pulled or pushed. An inclination sensor detects a slope of the traveling surface and generates a slope signal. A load sensor detects a load weight of the trolley and generates a load signal. A step-detection sensor detects a step in a path of the trolley and generates a corresponding signal. A controller receives all pertinent signal from the sensors and generates a control signal for actuating the drivetrain such that the drivetrain produces a driving force corresponding to the force applied to the handle by a user.

### CROSS-REFERENCE TO RELATED APPLICATIONS

This application claims foreign priority benefits under 35 U.S.C. § 119(a)-(d) to DE Application 10 2017 200 155.0 filed Jan. 9, 2017, which is hereby incorporated by reference in its entirety.

### TECHNICAL FIELD

The invention relates to a shopping trolley of the general type pulled or pushed by a pedestrian to transport goods, and more specifically to such a trolley having an electrically-powered drivetrain to provide motive force.

### BACKGROUND

Shopping trolleys, also referred to as shopping carts or grocery carts, are used by a person travelling on foot to transport e.g. purchases or empty containers.

Such shopping trolleys are composed of a metal frame with two wheels and a handle for pulling or pushing the frame and a separate bag which can be attached to the frame and in which the goods to be transported can be stowed.

The shopping trolley is usually pulled along behind a user. The pulling of the shopping trolley can be facilitated by virtue of the fact that the wheels are additionally driven by a motor or a plurality of motors. With respect to the motor drive it is to be borne in mind that when cornering occurs both wheels must rotate at different speeds. When drive is provided by means of a motor, this problem is generally solved by the additional use of a differential. This makes the drive considerably more expensive.

In order to provide a shopping trolley with a lightweight drivetrain, DE 10 2006 005 227 B3 discloses a motorized shopping trolley with two wheels and an axle which connects the two wheels, wherein the axle which connects the wheels has two releasable clutches, and wherein an electrically operated motor is arranged centrally on the axle, and between the two releasable clutches.

However, there is no coordination between the force made available by the drivetrain and a traction force on a handle of the shopping trolley.

It would therefore be advantageous to improve the coordination between the force made available by the drivetrain and a traction force on a handle of the shopping trolley by the trolley user.

### SUMMARY

The object of the invention is achieved by means of a shopping trolley, having a frame and having at least one wheel which is driven by a drivetrain in order to provide motive force to the trolley. A handle of the shopping trolley is assigned a force-detection sensor for detecting a force acting on the handle, and a controller is operative to receive from the sensor an input or signal which represents the acting force, and to generate a control signal for actuating the drivetrain, such that the drivetrain generates a driving force that corresponds to and is coordinated with the acting force.

In this context, the term “corresponding to” is intended to mean a driving force which is coordinated with the force applied to the handle (as detected by the force sensor) such that the driving force produces a rolling movement of the trolley that, given the amount of the force applied to the handle, would be expected by (feel “natural” to) the user. Therefore, the driving force may be approximately equal to the applied force when the trolley is on a level surface. However, the corresponding driving force can differ from the acting force to the extent that the difference is below a perception limit of a user. The traction force with which a user pulls on the handle in order to set the shopping trolley in motion is therefore detected. A driving force which corresponds to the traction force is made available at least by the drivetrain. At the beginning, before the shopping trolley is set in motion, a relatively large driving force may temporarily be provided in order to generate a breakaway torque, as necessary to overcome inertia and to facilitate initially setting the trolley in motion. Therefore, the coordination between the driving force which is provided by the drivetrain and a traction force acting on the handle of the shopping trolley (applied by the user) is improved.

According to one embodiment, the controller is designed to receive and utilize a signal representing an inclination of a surface on which it is positioned. The inclination can be a positive gradient (upslope) or a negative gradient (downslope). The controller evaluates the detected inclination, and generates corresponding control signals which cause the drivetrain to generate an increased driving force in the case of a positive gradient, while in the case of a negative gradient the drivetrain provides a braking effect.

According to a further embodiment, the shopping trolley has an inclination sensor for detecting the inclination of the travel surface. The shopping trolley is therefore embodied in an autonomous fashion.

According to a further embodiment, the shopping trolley has an interface for receiving a signal indicating an inclination of the rolling surface from a remote device or source separate from the trolley itself. Via the interface it is possible to receive a signal representing the inclination, which inclination has been acquired e.g. with a smartphone. It is therefore possible to dispense with a inclination sensor.

According to a further embodiment, the controller has a step-detection device for detecting steps, and the controller is operative to generate a control signal for actuating the drivetrain in such a way that the drivetrain provides a driving force sufficient to allow the trolley to climb or overcome the step. The step-detection device can have an interface for receiving image data from a camera mounted to or integral with the shopping trolley and/or for reading in image data of a camera of a remote device (such as a smartphone) and/or for reading in sensor data of an acceleration sensor of the shopping trolley. A step can be detected by evaluating the respective image data and/or sensor data. In response to the detection of a step, the control signal generates an actuating signal for activation of the drivetrain, with the result that the latter provides a driving force which at least assists a user in overcoming the step.

According to a further embodiment, the shopping trolley has a load sensor for detecting a weight or load of the shopping trolley, and the controller is operative to receive and take into account a signal from the sensor representing the load. For this purpose, the load sensor can e.g. have a force sensor or pressure sensor such as a piezo sensor. The additional load state of the shopping trolley can therefore be detected and a correspondingly increased driving force can be made available with the drivetrain.

According to a further embodiment, the controller is designed to control the shopping trolley autonomously. Therefore, during operation the shopping trolley follows a user without this user pulling on the handle of the shopping trolley. For this purpose, e.g. a connection can be configured to a smartphone of the user via which information, such as e.g. the speed and/or distance from the user, is transmitted to the controller. The distance from the user can be determined e.g. by means of ultrasound. In addition, ambient data which originates from other sources such as e.g. portable computer systems can also be taken into account.

According to a further embodiment, the shopping trolley has at least one additional, folding-out wheel. For example, the folding-out wheel can be assigned to the handle. A load-carrying surface which is supported on all sides can be made available by the additional folding-out wheel. The shopping trolley can therefore be used in a particularly versatile fashion.

According to one further embodiment, the shopping trolley has a load-carrying surface which is embodied as a standing surface for a standing user. It is therefore possible for the shopping trolley also to be used for transporting users. The user can in this context control the shopping trolley with the handle, i.e. the controller is designed to receive and evaluate control signals at the handle, in order to convert them into corresponding signals.

In addition, a controller for such a shopping trolley forms part of the invention.

The invention will now be explained with reference to a drawing, in which:

### BRIEF DESCRIPTION OF THE DRAWINGS

FIG. 1 shows a schematic illustration of a shopping trolley;

FIG. 2 shows further components of the shopping trolley;

FIG. 3 shows a schematic illustration of the shopping trolley shown in FIG. 1, in a further position of use; and

FIG. 4 shows a schematic illustration of the shopping trolley shown in FIG. 1, in a further position of use.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

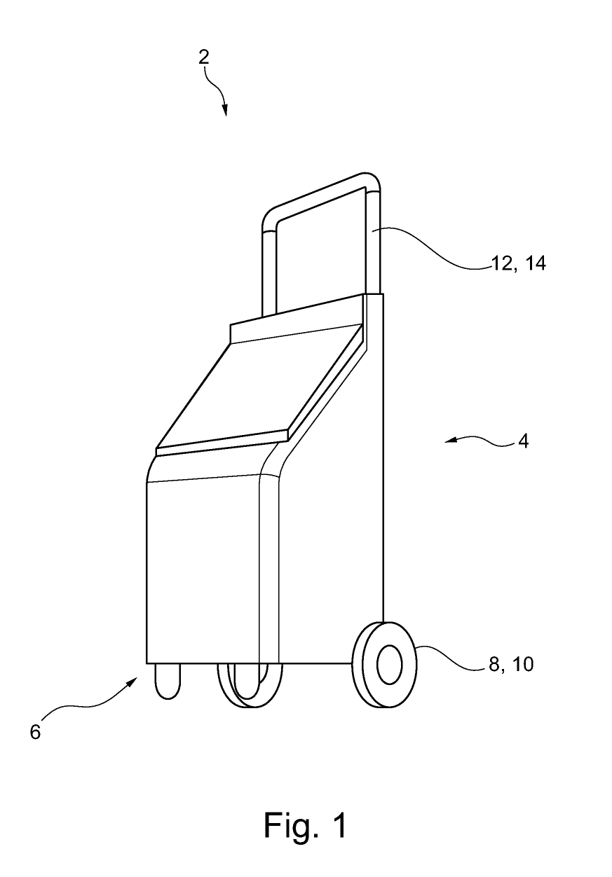

Referring initially to FIG. 1, a shopping trolley 2 is illustrated. The shopping trolley 2 has a frame 4 which provides a load-carrying surface 6, e.g. for a bag.

In the present exemplary embodiment, two wheels 8, which are driven by a drivetrain 10 which in the present exemplary embodiment comprises two electric motors, one of which is respectively assigned to each of the two wheels 8, are attached to the frame 4. In order to supply electrical power to the drivetrain 10, a battery (not illustrated) or a fuel cell (not illustrated) can be provided. The battery can be assigned a charger unit for charging the battery via an onboard system of a motor vehicle, while the fuel cell can be supplied, e.g. with hydrogen, from a tank.

In addition, a handle 12, with which a user can pull and/or push the shopping trolley 2, is provided on the frame 4. A force-detection device 14 for detecting a force acting on the handle 12 is located on or near the handle 12.

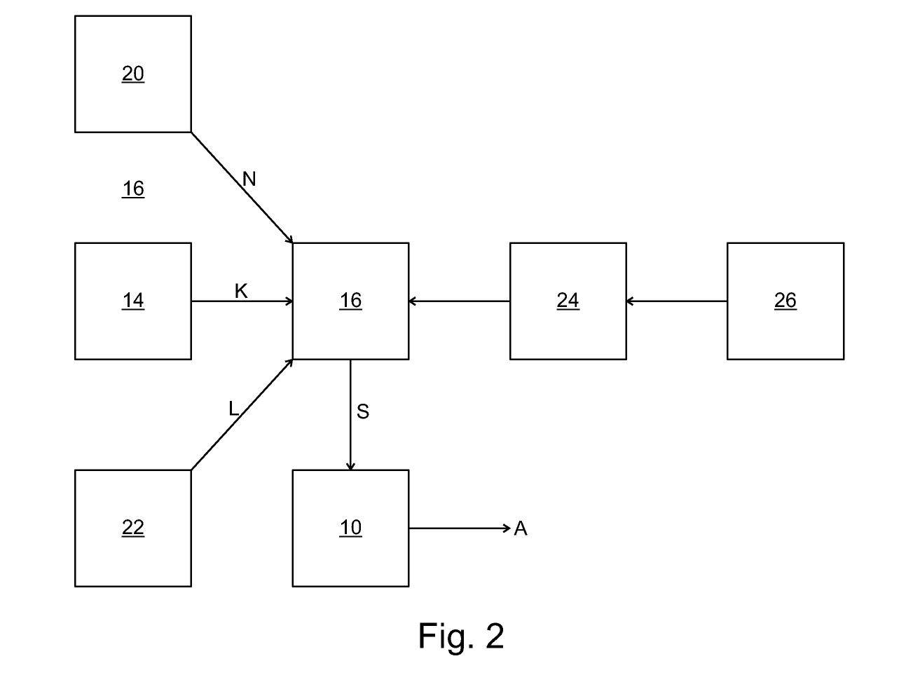

As indicated schematically in FIG. 2, the shopping trolley 2 additionally has a controller 16. The controller 16 is connected to the force-detection device 14 in order to receive therefrom a signal indicating the acting force F acting on the handle 12, as would be applied by a user's hand while pushing or pulling the trolley. In addition, in the present exemplary embodiment, the controller 16 is connected to an inclination sensor 20 of the shopping trolley 2, and can receive therefrom an inclination signal N which characterizes the slope of the rolling surface on which the trolley is positioned.

Furthermore, in the present exemplary embodiment, the controller 16 is connected to a load sensor 22 of the shopping trolley 2, and can receive therefrom a weight or load L which is detected with the load sensor 22, e.g. the weight of goods supported on the load-carrying surface 6.

Furthermore, in the present exemplary embodiment, the controller 16 has an interface 24 with which a connection can be set up to a remote device 26 such as e.g. a smartphone, with the result that e.g. data, such as e.g. values of an inclination N, can also be received from the smartphone 26.

During operation, the controller 16 receives signals indicating the values for the acting force K, the inclination N and the load L. The controller 16 evaluates the values and generates a control signal S for actuating the drivetrain 10, in order to provide a driving force A corresponding to and coordinated with the acting force K. In this context, in the case of a positive gradient the drivetrain 10 generates a driving force A which acts in the direction of travel, that is to say is an accelerating driving force A, while in the case of a negative gradient the drivetrain 10 provides a braking force, that is to say a driving force A with a negative sign.

In the present exemplary embodiment, the controller 16 has a step-detection device with which a step in a path of the trolley can be detected. In response to a detected step, the controller 16 provides a control signal S for actuating the drivetrain 10, in such a way that the drivetrain 10 generates a driving force A sufficient to allow the trolley to climb the step. The step-detection device can be designed to receive image data of a camera which is integral with or mounted to the shopping trolley 2. Alternatively, or additionally, the step-detection device can be designed to receive image data from a camera of a remote device 26 (such as a smartphone) via the interface 24. Furthermore, there can alternatively or additionally be provision for sensor data of an acceleration sensor of the shopping trolley 2 to be received.

In addition, in the present exemplary embodiment, the controller 16 is designed to control the shopping trolley 2 autonomously. During autonomous operation, the shopping trolley 2 follows a user without the user pulling on the handle 12 of the shopping trolley 2. For this purpose, e.g. a connection to a remote device 26 operated by the user can be established via the interface 24, in order to transmit information, such as e.g. speed and/or distance from the user, to the controller 16. The distance from the user can be determined e.g. by means of ultrasound. In addition, it is also possible to take into account ambient data, which data originates from other sources, such as e.g. portable computer systems.

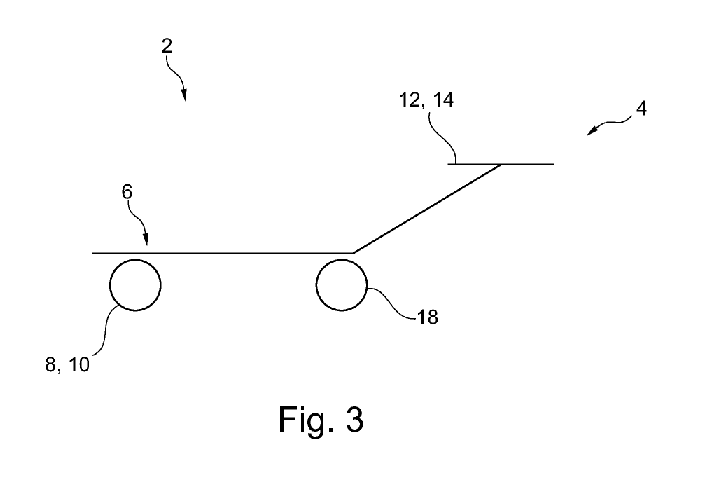

Referring now to FIG. 3, a shopping trolley 2 has two additional folding-out wheels 18. In the present exemplary embodiment, the two additional folding-out wheels 18 are assigned to the handle 12. A load-carrying surface 6 which is supported on all sides is made available by means of the two additional folding-out wheels 18. The number of folding-out wheels can, in contrast to the present exemplary embodiment, be smaller or greater than two. In particular, one folding-out wheel is also sufficient.

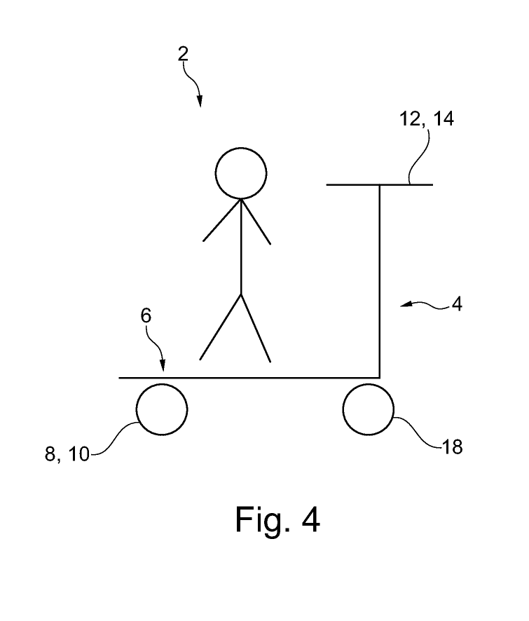

Reference will additionally be made to FIG. 4, which illustrates that the load-carrying surface 6 can form a standing surface for a user to stand on the shopping trolley 2. Therefore, the shopping trolley 2 can also be used for transporting users. Control is possible here via the handle 12. For this purpose, the controller 16 is designed to receive and evaluate control signals for the acceleration, braking and steering lock at the handle 12, in order to convert said control signals into corresponding signals.

Therefore, a shopping trolley 2 which can be used in a particularly versatile way is made available.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A shopping trolley comprising:
a frame;
at least one wheel mounted to the frame;
an electrically-powered drivetrain operative to rotate the at least one wheel;
a handle graspable by a user to push and/or pull the trolley;
a force sensor operative to detect a force applied to the handle by the user and output, in response thereto, a first signal; and
a controller operative to receive the first signal and output, in response thereto, a control signal to actuate the drivetrain to produce a drive force corresponding to the force applied to the handle.

2. The shopping trolley of claim 1, wherein the controller, in generating the control signal, further utilizes a second signal representing an inclination of a rolling surface.

3. The shopping trolley of claim 2, further comprising an inclination sensor operative to generate the second signal.

4. The shopping trolley of claim 2, further comprising an interface operative to receive the second signal from a remote device.

5. The shopping trolley of claim 1, further comprising a step-detection device operative to detect a step in a path of the trolley, and wherein the controller is operative to generate the control signal in such a way that the driving force is adapted to cause the trolley to climb the step.

6. The shopping trolley of claim 1, further comprising a load sensor operative to detect a weight of the shopping trolley and generating a load signal, and wherein the controller, in generating the control signal, further utilizes the load signal.

7. The shopping trolley of claim 1, wherein the controller is further operative in an autonomous mode wherein the controller receives a signal from a remote device and generates the control signal such that the shopping trolley follows a user.

8. A shopping trolley comprising:
a frame having a handle and at least one wheel driven by a motor;
a sensor detecting a force applied to the handle by a user's hand; and
a controller receiving an input from the sensor and generating therefrom a control signal which actuates the motor to produce a drive force in reaction to the applied force.

9. The shopping trolley of claim 8, wherein the controller further receives a second input representing an inclination of a rolling surface, and the controller utilizes the second input to generate the control signal.

10. The shopping trolley of claim 9, further comprising an inclination sensor generating the second input.

11. The shopping trolley of claim 9, further comprising an interface receiving the second input from a remote device.

12. The shopping trolley of claim 8, further comprising a step-detection device detecting a step in a path of the trolley, and wherein the controller generates the control signal in such a way that the driving force is adapted to cause the trolley to climb the step.

13. The shopping trolley of claim 8, further comprising a load sensor detecting a weight of the shopping trolley and generating a load signal, and wherein the controller, in generating the control signal, further utilizes the load signal.

14. The shopping trolley of claim 8, wherein the controller is further operative in an autonomous mode wherein the controller receives a signal from a remote device and generates the control signal such that the shopping trolley follows a user.
